(19) United States
(12) Patent Application Publication
(10) Pub. No.: US 2020/0055417 A1
(43) Pub. Date: Feb. 20, 2020

(54) POSITIONING UNIT AND METHOD FOR CONTACTING

(71) Applicant: SCHUNK BAHN- UND INDUSTRIETECHNIK GMBH, Bergheim (AT)

(72) Inventor: ALEXANDER PACHLER, Salzburg (AT)

(21) Appl. No.: 16/462,756

(22) PCT Filed: Nov. 1, 2017
(86) PCT No.: PCT/EP2017/077972

§ 371 Date: May 21, 2019

(30) Foreign Application Priority Data
Nov. 22, 2016 (DE) 10 2016 223 051.4

(51) Int. Cl. B60L 53/37; B60L 53/16; B60L 53/31; B60L 53/39; B60L 5/42; B60L 5/28; B25J 9/04

(52) U.S. Cl. CPC B60L 53/37; B60L 53/16; B60L 53/31; B25J 9/042; B60L 5/42; B60L 5/28; B60L 53/39

(57) ABSTRACT

The invention relates to a positioning unit and to a method for forming an electrically conductive connection between a stationary charging station and a vehicle, in particular an electric bus or similar, wherein an electrical charging contact of the positioning unit can be moved relative to a charging contact surface and contacted with same by means of the positioning unit, wherein the positioning unit has an articulated arm device and a drive device for driving the articulated arm device, wherein the charging contact can be positioned between a contact position for power transmission and a retracted position for power interruption by means of the articulated arm device, wherein the drive device has an adjustment drive for forming an adjustment force acting on the articulated arm device, wherein the drive device has a control device by means of which the adjustment drive can be actuated, wherein the drive device has a sensor device by means of which the charging contact surface can be detected, wherein the sensor device is coupled with the control device, wherein a speed of the charging contact during movement of the charging contact from the retracted position into the contact position can be controlled by the control device in accordance with a relative distance between the charging contact and the charging contact surface.

This invention relates to a positioning unit and to a method for forming an electrically conductive connection between a stationary charging station and a vehicle, in particular an electric bus or similar, wherein an electrical charging contact of the positioning unit can be moved relative to a charging contact surface and contacted with same by means of the positioning unit, wherein the positioning unit has an articulated arm device and a drive device for driving the articulated arm device, wherein the charging contact can be positioned between a contact position for power transmission and a retracted position for power interruption by means of the articulated arm device, wherein the drive device has an adjustment drive for forming an adjustment force acting on the articulated arm device, wherein the drive device has a control device by means of which the adjustment drive can be actuated.

Such positioning units and methods are known from the state of the art and are regularly used for electrically driven vehicles that operate between stations. This could refer to electric busses but basically also other vehicles, for example a train or a tram, that are not permanently electrically connected to a contact wire or similar. With these vehicles, charging of an electrical energy storage takes place through a charging station while the vehicle is stopping at a station. At the station, the vehicle is electrically connected to the charging station, wherein the energy storage is recharged at least enough for the vehicle to reach the next station with a charging station. To establish an electrical connection between the vehicle and the charging station, a positioning unit that can be mounted on a roof of the vehicle or alternatively above the vehicle, for example on a pole, is used. The positioning unit is then able to connect a charging contact with a charging contact surface, enabling the vehicle or rather the energy storage to be charged at the station.

When connecting the charging contact with the charging contact surface it is essential that the charging contact is pressed onto the charging contact surface with a defined contact force to be able to establish a safe electrical connection. From DE 202014007218 U1 a positioning unit above a vehicle is known, wherein the positioning unit comprises an articulated arm device and a drive device. The drive device has an adjustment drive and a spring device that serve the purpose of moving the articulated arm device relatively to the charging contact surface of the vehicle. Especially an upward movement of the articulated arm device requires an adjustment force of the adjustment drive.

With known positioning units it is always disadvantageous that they have to be designed and arranged for a defined contact height, meaning a distance of the positioning unit in a retracted position for the storage of the charging contact relative to a contact position for the power transmission to the vehicle. This means that a relative distance between the contact position and the retracted position is not variably useable and has to be frequently set or adjusted through structural changes because otherwise the necessary or desired contact force cannot be applied onto the charging contact surface. Especially when vehicle types and thus the heights of the vehicles change, a relative distance between the retracted position and the contact position can vary widely as a result of height differences of the vehicles' contact surfaces above a road. The same applies to different loads of a vehicle or the lowering of a vehicle or a bus in the area of a station to facilitate entry for persons with, for example, physical impairments. When the vehicle is lowered, the charging contact moves in the vertical direction relative to the charging contact surface if the contact force can no longer be upheld.

Another disadvantage is that when the charging contact is being extended, said extending of the charging contact is relatively slow. If a vehicle is supposed to be charged during a stop in the area of a station, however, a stopping time of the vehicle should be used as effectively as possible for charging the vehicle. However, it is not always easily possible to extend the electrical charging contact as quickly as possible and to thus quickly contact the charging contact surface with the charging contact because the electrical charging contact or the charging contact surface might become damaged during the contacting process or might wear relatively quickly. Moreover, the meeting of the charging contact and the charging contact surface may produce undesired noise that might disturb or unsettle passengers or people living in the vicinity of the station.

It is therefore the object of the invention to propose a positioning unit and a method for forming an electrically conductive connection between a vehicle and a charging station which allow a prolonged charging time and safe contacting of the vehicle.

This object is attained by a positioning unit with the characteristics of claim 1 and a method with the characteristics of claim 11.

The positioning unit according to the invention for forming an electrically conductive connection between a stationary charging station and a vehicle, in particular an electric bus or similar, is designed in such a way that an electrical charging contact of the positioning unit can be moved relative to a charging contact surface and contacted with same by means of the positioning unit, wherein the positioning unit has an articulated arm device and a drive device for driving the articulated arm device, wherein the charging contact can be positioned between a contact position for power transmission and a retracted position for power interruption by means of the articulated arm device, wherein the drive device has an adjustment drive for forming an adjustment force acting on the articulated arm device, wherein die drive device has a control device by means of which the adjustment drive can be actuated, wherein the drive device has a sensor device by means of which the charging contact surface or to the charging contact can be detected, wherein the sensor device is coupled with the control device, wherein a speed of the charging contact during movement of the charging contact from the retracted position into the contact position can be controlled by the control device in accordance with a relative distance between the charging contact and the charging contact surface.

The positioning unit can therefore be part of a stationary charging station for an electrically driven vehicle or part of an electrically driven vehicle, wherein the positioning unit serves the purpose of moving the charging contact of the charging station or of the vehicle onto a charging contact surface of the vehicle or of the charging station and electronically connect it thereto. It is then possible to provide the vehicle with electrical energy during a stop at the charging station and to store this energy in the vehicle. The movement of the charging contact onto the charging contact surface and back is performed by the articulated arm device and the drive device of the positioning unit. For this purpose, the charging contact is located at one end of the articulated arm device. The drive device serves the purpose of moving the charging contact and therefore the articulated arm device from a retracted position for the storage of the charging contact to a contact position for the power transmission or the contacting of the charging contact surface with the charging contact. The adjustment force acting on the articulated arm device is produced by the adjustment drive of the drive device. The adjustment force depends on a mechanism of the articulated arm device or a transmission of the adjustment drive and hardly changes during a movement of the charging contact.

Moreover, the drive device has the control device, which can also be in the form of control electronics for the adjustment drive, for example. The control electronics can be integrated directly in the adjustment drive, in the vehicle or in the charging station. Furthermore, it is possible to detect or register the charging contact surface or the charging contact by means of the sensor device and to determine their position. Since the sensor device is coupled with the control device, it becomes possible to determine a relative distance between the charging contact and the charging contact surface or to calculate it using the control device. In this regard, it is basically immaterial whether the sensor device is connected to the control device directly via electrical lines or whether the coupling is wireless. By determining the relative distance, it becomes possible to control the speed of the charging contact during a movement of the charging contact from the retracted position into the contact position by means of the control device in accordance with the relative distance between the charging contact and the charging contact surface. In this way, it does not matter how high a speed is at first as long as the charging contact moves slowly enough in the last phase of the movement of the charging contact from the retracted position into the contact position that the charging contact or the charging contact surface do not sustain any damage and/or that no undesired levels of noise are produced by the contacting process. This control of the extending movement and speed of the charging contact enables faster contacting of the charging contact with a charging contact surface by comparison so that a charging time of a vehicle during a stop at a station can be advantageously prolonged. At the same time, noise emission during contacting of the charging contact and the charging contact surface can be advantageously influenced. Optionally, a movement of the charging contact from the contact position into the retracted position can be controlled by means of the control device in the same way.

The adjustment drive can form a contact force acting on the charging contact surface, wherein the adjustment drive can have the control device and an electric motor which can be actuated by means of the control device. Thus, in the contact position, a defined contact force acting on the charging contact surface can be formed by the positioning unit. In the retracted position, on the other hand, no or only very little adjusting force can act on the articulated arm device, meaning that the articulated arm device and the charging contact cannot move. During contacting of the charging contact and the charging contact surface, the adjustment force can be increased by the adjustment drive, which causes the contact force acting on the charging contact surface to be formed or increased. The control device can in particular detect a torque of the electric motor through, for example, the energy spent and can control the electric motor in such a way that the defined contact force of the electric motor is exerted onto the charging contact surface via the articulated arm device and the charging contact. It is then possible to actively adjust a direct force action onto the articulated arm device and, if applicable, onto the charging contact, optionally also in accordance with various influencing factors. Thereby an ever-constant contact force acting onto the charging contact surface irrespective of a relative distance between the charging contact surface and of the positioning unit or of a height of the vehicle can be formed.

If the adjustment drive has a brushless electric motor, a particularly large number of movement cycles can be performed. A brushless electric motor requires significantly fewer and longer maintenance intervals than a brushed electric motor having the same mechanical performance characteristics. Thereby it is overall possible to design a positioning unit with extended maintenance intervals or with a longer service life. A three-phase asynchronous induction machine with a squirrel-cage rotor or also an a synchronous machine with electronic generation of a rotary field or a brushless dc motor can, for example, be used as a brushless motor or electric motor without sliding contacts between rotor and stator.

The adjustment drive can be a linear drive, preferably a spindle drive, particularly preferably a spindle drive without self-locking. The spindle drive can then have a corresponding spindle with a pitch that can prevent self-locking of the spindle drive. The linear drive can cause movement of the articulated arm device from the retracted position into the contact position and vice versa. The spindle can in particular be a ball screw spindle or a trapezoidal thread spindle that can be coupled to an electric motor.

The sensor device can have at least one sensor, wherein the sensor can be a mechanical switch, and inductive sensor, a capacitive sensor, a magnetic sensor, an ultrasonic sensor, a radar sensor and/or an optical sensor. The sensor device can optionally also have a number of multiple sensors of the same or a different type. In this way, it can be ensured that at least one sensor can detect the charging contact surface in case a sensor fails or in case of varying environmental conditions. In a simple embodiment, the sensor can be a mechanical switch which establishes contact with the charging contact surface, thus being triggered, even prior to the charging contact. Inductive and capacitive proximity sensors are particularly advantageous if only a small switching distance is required. Larger switching distances can be realized using a magnetic sensor. An ultrasonic sensor has sufficient range and is relatively robust. A radar sensor can still measure a distance to the charging contact surface if the latter is covered with a layer of dirt or snow. Optical sensors are particularly suitable for distance measurement and are relatively independent from environmental conditions. An optical sensor can be realized using infrared light, laser or simple light-emitting diodes.

The sensor can be disposed on the articulated arm device, in particular adjacent to the charging contact, or on the charging contact surface. The substantial aspect is that the sensor is disposed in such a manner that it can detect a relative distance between the charging contact surface and the charging contact. It may be envisaged in this context that the sensor is disposed at a distal end of the articulated arm device close to the charging contact. The sensor can also be disposed on the charging contact surface if the sensor can then detect the charging contact and the relative distance. The sensor disposed on the charging contact surface can wirelessly transmit distance information to the control device, for example. In this case, it is possible to equip charging stations with corresponding sensors even if the control device is mounted on the vehicle or vice-versa.

The adjustment drive and/or the articulated arm device can have a displacement sensor and/or a position sensor. By using a displacement sensor it is then possible to set a range in which the articulated arm device can move by means of the adjustment drive. An incremental encoder or an absolute encoder can, for example, be used as a displacement sensor. It is then also possible to define an exact working position of the adjustment drive or of the charging contact at all times. The adjustment drive can also have limit switches that can be operated depending on the position and/or pressure switches that can be operated depending on the force. Furthermore, a height of a contact force can also be limited by snaking the adjustment drive extendable only to a certain limited position. In addition, pressure switches for the limitation of the contact force that can serve as a limitation for the adjustment drive themselves or together with the limit switches can additionally be used. A pressure switch can be located directly on the charging contact or also on the articulated arm device or on the adjustment drive. However, these sensors are not part of the sensor device, which is why they cannot be used to directly determine the relative distance between the charging contact and the charging contact surface.

The drive device can have a spring device which mechanically cooperates with the adjustment drive. The spring device can have at least one tension spring or one compression spring that can generate a spring force on the articulated arm device. The use of a tension spring is preferred because a tension spring can be connected especially easily to the articulated arm device. It can also be intended that the spring device has a plurality of springs and that the spring force is constantly acting on the articulated arm device. The spring can therefore be prestressed in each position of the articulated arm device. A compression spring can alternatively be used for forming the spring force. Such a spring device is particularly robust and can be produced easily and inexpensively.

A spring of the spring device can be mechanically coupled with the articulated arm device by means of a lever of a transmission of the spring device, wherein an effective length of the lever is designed to be variable in accordance with a position of the articulated arm device. The lever can therefore be attached directly to the articulated arm device, so that a spring force of the spring can directly be transferred onto the articulated arm device. Depending on the position or the direction of the spring force of the spring and the arrangement of the lever on the articulated arm device, the effective length of the lever can be shortened if an angle between the direction of the spring force and the extension of the lever is less than or greater than 90°. An effective length of the lever can also be adjusted by attaching the spring to the articulated arm device via a restoring gear, for example formed by a cam or a drawbar, with an end stop. The cam then forms the lever of the restoring gear. Depending on the position of the cam relative to the spring, the effective length of the lever can be affected. This way it is possible to achieve the same amount of restoring force on the articulated arm device at all times irrespective of a position of the articulated arm device or to increase or decrease the restoring force in accordance with a position of the articulated arm device according to the respective requirements. The restoring force can also be matched to the adjustment force and the contact force. It is advantageous for the restoring force to be determined in such a way that a retracting of the charging contact takes place automatically as a result of the restoring force in every position of the articulated arm device if the adjustment drive fails, for example due to a power outage. This way, the positioning unit can be operated in a particularly safe manner.

In an advantageous embodiment, the positioning unit comprises a holding device for fixing the positioning unit to a pole or an underpass above a vehicle, wherein the spring device can comprise at least a restoring spring for forming a restoring force acting on the articulated arm device, wherein the restoring force is then greater than a gravitational force of the articulated arm device acting on the restoring spring in the opposite direction. The holding frame can, for example, form or comprise fixed bearings for the articulated arm device and the adjustment drive. In particular, the restoring spring or the adjustment drive can be attached directly to a fixed bearing on the holding frame. The holding frame can also be attached especially simply to the pole or the underpass as well as to a roof of a station, a tunnel or similar facilities that vehicles can drive under. Due to the fact that the positioning unit can be arranged above a vehicle, the adjustment drive can be formed as a lowering drive for lowering the contact element and cooperate mechanically with the spring device or the restoring spring. The charging contact can be easily restored into the retracted position on the positioning unit above the vehicle after a contacting of the charging contact surface with the charging contact if the spring device generates the restoring force on the articulated arm device by means of the at least the one restoring spring. Due to the restoring force then possibly being greater than a gravitational force of the articulated arm device acting on the restoring spring in the opposite direction, the articulated arm device can be moved from the contact position to the retracted position without the adjustment drive being active or supplied with power. Even if the charging contact is located in the retracted position, the restoring force is then counteracting the gravitational force and is preferably slightly greater than the gravitational force in order to prevent the charging contact from lowering or extending when there is no additional force acting on the articulated arm device.

In another advantageous embodiment, the positioning unit can comprise a holding device for fixing the positioning unit on the roof of a vehicle, wherein the spring device can comprise at least one lifting spring for forming of a lifting force acting on the articulated arm device, wherein the lifting force can then be smaller than a gravitational force of the articulated arm device acting on the lifting spring in the opposite direction. The holding frame can also form or comprise fixed bearings for the articulated arm device and the drive device, though it is then attached to the roof of the vehicle. The holding frame can be easily mounted on the roof via dampers, feet and/or isolators. In this way, the positioning unit can be exchanged especially easily. If the positioning unit is mounted on the roof of the vehicle, the adjustment drive can be a lifting drive for extending the charging contact that can cooperate mechanically with the spring device. A contacting of the charging contact surface with the charging contact can in this case also be performed simply by extending the charging contact into the contact position if the spring device comprises at least the lifting spring for forming the lifting force that, in cooperation with the adjustment force of the adjustment drive, acts on the articulated arm device, wherein the lifting force can be smaller than a gravitational force of the articulated arm device acting on the lifting spring in the opposite direction. Thus, a gravitational force of the articulated arm device and of the charging contact located on the articulated arm device can cause the articulated arm device to move from the contact position to the retracted position without this being initiated by the adjustment drive. The gravitational force acting in the opposite direction of the lifting force is preferably slightly smaller than the gravitational force in order to ensure the lowering of the charging contact in the case of, for example, a power outage. Furthermore, the lifting force is nevertheless supporting the adjustment drive when the latter causes the adjustment force acting on the articulated arm device during extension of the articulated arm device, so that only a small adjustment force needs to be exerted.

The articulated arm device can be designed as a single-arm system or as a scissors mechanism, preferably with a parallelogram linkage or as a pantograph. Thereby the articulated arm device can allow parallel movement of the charging contact starting from a retracted position of the charging contact towards the contact position on the charging contact surface. Additional damper elements that ensure a smooth motion sequence can be arranged on the articulated arm device.

The drive device can be configured for coupling with a data bus of a vehicle. This way, the adjustment drive can be actuated directly via the data bus, for example. The sensor device can also be connected to the data bus, allowing the control device to be disposed anywhere in the vehicle.

In the method according to the invention for forming an electrically conductive connection between a stationary charging station and a vehicle, in particular an electric bus or similar, an electrical charging contact of the positioning unit can be moved relative to a charging contact surface and contacted with same by means of the positioning unit, wherein an articulated arm device of the positioning unit is driven by a drive device of the positioning unit, wherein the charging contact can be positioned between a contact position for power transmission and a retracted position for power interruption by means of the articulated arm device, wherein an adjustment force acting on the articulated arm device is formed by means of an adjustment drive of the drive device and wherein the adjustment drive is actuated by means of a control device of the drive device, wherein the charging contact surface or the charging contact is detected by means of a sensor device of the drive device, wherein the sensor device is coupled with the control device, wherein a speed of the charging contact during movement of the charging contact from the retracted position into the contact position is controlled by the control device in accordance with a relative distance between the charging contact and the charging contact surface. With regard to the advantageous effects of the method according to the invention, reference is made to the description of advantages of the positioning unit according to the invention.

During movement of the charging contact from the retracted position into the contact position, the charging contact can undergo positive acceleration at first and negative acceleration at a later point. In particular after detection of the charging contact surface or of the charging contact, the negative acceleration can then act on the charging contact with a predetermined relative distance between the charging contact and the charging contact surface.

During movement of the charging contact from the retracted position into the contact position, the charging contact can be moved at constant and/or maximum speed in a first movement section and can be moved at a relatively reduced speed in a second movement section prior to arrival in the contact position. This means that the charging contact is first extended from the retracted position as quickly as possible in order to be decelerated shortly prior to the contact position and to contact it with the charging contact surface. By controlling the extension of the charging contact in this way, contact between the charging contact and the charging contact surface can be established more quickly than before, whereby a charging time can be advantageously prolonged. Moreover, the charging contact can be decelerated before reaching the charging contact surface in such a manner or its speed can be reduced in such a manner that the charging contact and the charging contact surface come into contact relatively slowly. The probability of mechanical damage to the charging contact and to the charging contact surface and wear thereof can be reduced in this way. Furthermore, there is hardly any disturbing noise during contacting.

The constant or maximum speed can be ≥100 mm per second, preferably ≥360 mm per second, particularly preferably ≥500 mm per second.

The reduced speed upon arrival in the contact position can be at least 70%, preferably 50%, particularly preferably 30% of the constant and/or maximum speed or 0 mm per second. Thus, it is ensured that the charging contact does not hit the charging contact surface at maximum speed. By determining the relative distance, the control device can also lower the reduced speed far enough that it is 0 mm per second or that the charging contact is stopped upon arrival in the contact position.

The speed can be reduced at a relative distance of ≤150 mm, preferably ≤100 mm, particularly preferably ≤50 mm prior to arrival in the contact position. Said relative distance is still in the detection range of various sensors and can thus also be easily determined by the sensor device. Also, the charging contact can be moved at high speed across a large section of its path in the direction of the charging contact surface.

It is particularly advantageous if the speed can be reduced according to a linear function or an approximation function prior to arrival in the contact position. The control device can have a control element that controls the reduction of the speed after a signal from the sensor device, for example, when the charging contact goes below a defined relative distance.

Also, at least one sensor of the sensor device can continuously transmit a distance value or a defined threshold of the relative distance of the control device. For instance, it may be envisaged that the sensor permanently transmits the relative distance or a current value of the relative distance to the control device. Alternatively, the sensor can transmit a signal to the control device at least once if the distance falls short of the previously defined relative distance. Upon receipt of the signal, the control device can then reduce the speed of the charging contact.

The adjustment drive can exert a contact force on the charging contact surface, wherein an electric motor of the adjustment drive can be actuated by the control device.

A torque of the electric motor can be detected by the control device, wherein the contact force can be controlled by the control device in accordance with the torque of the electric motor.

The contact force can be formed independent from a relative distance of the charging contact surface or of the contact position to the retracted position of the positioning unit. Therefore, it is possible to also contact vehicles that have different heights relative to a road with the positioning unit.

In the contact position, during adjustment of a relative distance of the charging contact surface or of the contact position from the retracted position of the positioning unit, the contact force can be constant. A change of a relative distance of a vehicle to the road always results in a change of the relative distance between the contact position and the retracted position as well. A change of the relative distance can be caused by the vehicle being lowered via a running gear or by the vehicle being loaded. Since the contact force is comparatively large relative to the adjustment force, the contact force can be substantially constant, even if the relative distance is changed. A constant contact force can be formed even more easily independent from the relative distance if the contact force is controlled by the control device in accordance with the torque of the electric motor. If the relative distance is increased by lowering the vehicle, the contact force and thus directly a torque of the electric motor decrease, the torque then being increased again by the control device, resulting in a constant contact force. Vice versa, decreasing the relative distance leads to an increase of a contact force and thus of the torque, which the control device can counteract by decreasing the torque.

The torque of the electric motor can be set in accordance with a position of the articulated arm device or the adjustment drive by means of the control device. Thereby it is then possible for a direct force action on the articulated arm device and, if applicable, on the contact element to be ideally matched to the respective position of the articulated arm device and therefore also for the direct force acting on the charging contact surface to be substantially constant irrespective of the position of the articulated arm device. A position of the articulated arm device can be detected through, for example, a displacement sensor and the torque can be adjusted beforehand in accordance with the position by the control device, so that controlling the torque for the adjustment of the contact force will not require any large torque steps.

When a limit value of the torque is exceeded, the control device can also detect that the contact position has been reached. The charging contact encounters the charging contact surface in the contact position, which causes the torque of the electric motor to increase significantly. This increase of the torque can be detected as the arrival of the control device in the contact position. For example, a possibly existing speed control of the electric motor can then be turned off because it is only necessary to readjust the torque of the electric motor in the contact position. Also, an enable signal for the transfer of energy from a charging station can then be released in the contact position by means of the control device, for example. Further sensors for the detection of the contact position are therefore not necessary.

The torque of the electric motor can be limited and constantly maintained by means of the control device once a target value of the torque has been reached. By limiting the torque, overloading of the electric motor is prevented as a start. Furthermore, it is then also possible to make the contact force constant. The same applies to an extension and a retracting speed of the charging contact, which can then be increased within limits.

The target value of the torque can be controlled within a tolerance range of +/−10% by means of the control device. This tolerance range is completely sufficient for forming a substantially constant contact force, so that a particularly precise detection of the torque of the electric motor through the control device is unnecessary. The control device can therefore be designed in a more inexpensive manner.

A maximum speed of the electric motor can be reached within a period of 0 to 7 seconds of the motor running, preferably within 1 to 3 seconds, by means of the control device. In this way, a direct force action as well as vibrations of the adjustment drive and the articulated arm device can be avoided or reduced. The thus controlled starting of the electric motor then also leads to an extension of a service life of the positioning unit.

The speed of the electric motor can be controlled by means of the control device in such a way that the charging contact is being moved at a constant velocity at least in sections. For example, it can be envisaged that, starting from the retracted position, the charging contact is extended with an initially positive acceleration or retracted with a negative acceleration, but that a major part of the distance of a movement of the charging contact into the contact position takes place at constant speed.

The charging station or the vehicle can be detected by another sensor device of the drive device, wherein the control device can detect a relative distance of the charging contact in the retracted position and in the contact position, wherein the control device can initiate the movement of the charging contact out of the retracted position before the vehicle stops at the charging station. Accordingly, the other sensor device can determine a horizontal distance between the vehicle and the charging station, wherein the charging contact can be extended from the retracted position in a controlled manner as soon as the distance of the charging contact falls below a threshold so that when the vehicle is located in the position intended for charging below the charging station, the charging contact is already located closely below the charging contact surface or vice-versa. In this way, a charging time can be advantageously prolonged even further. Vice-versa, the charging station can have the charging contact and the vehicle can have the charging contact surface, of course. The other sensor device can also have at least one of the mentioned sensors. If applicable, the other sensor device can also be integrated in the sensor device.

The control device can determine a relative height of the charging contact and/or of the contact position above a vehicle, wherein the control device can determine a height of the vehicle above a road. For instance, it is advantageous if a height of the vehicle above the road is known, in particular because this height can vary widely depending on a load of the vehicle. For example, the height can be determined through a chassis of the vehicle or through sensors specifically designed for this purpose. The control device can calculate a height of the charging contact relative to the road based on the height of the vehicle above the road and based on the position of the charging contact relative to the vehicle in the retracted position. If the height of the charging contact surface above the road is known, such as in the case of a charging station, an extending speed or a maximum speed o of the charging contact during extension from the retracted position can be controlled even before the vehicle has reached the charging station.

Further advantageous embodiments of the method are apparent from the dependent claims referring back to device claim 1.

In the following, preferred embodiments of the invention are explained in more detail with the aid of the attached drawings.

In the figures:

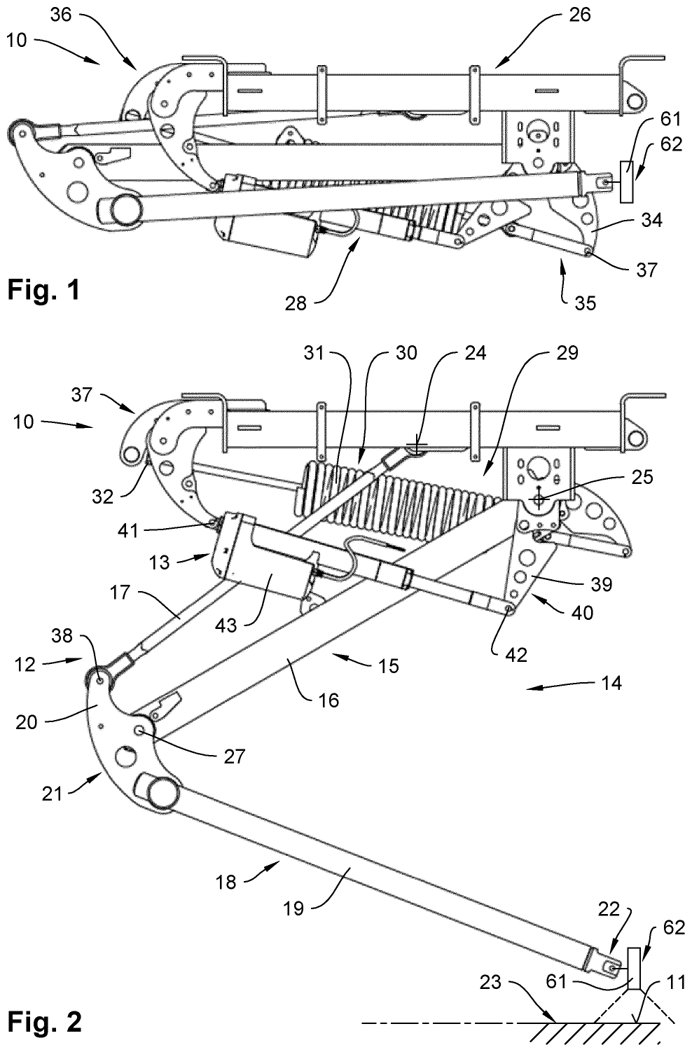

FIG. 1 shows a first embodiment of a positioning unit in a retracted position in side view;

FIG. 2 shows the positioning unit in a contact position in side view;

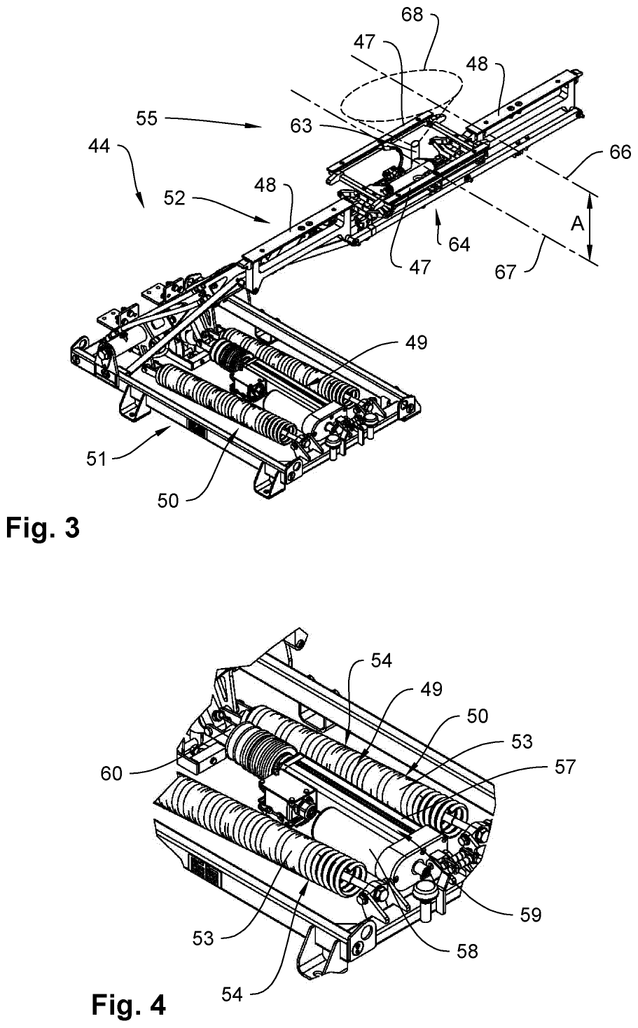

FIG. 3 shows a second embodiment of a positioning unit in a contact position in a perspective view;

FIG. 4 shows a detailed view of FIG. 3;

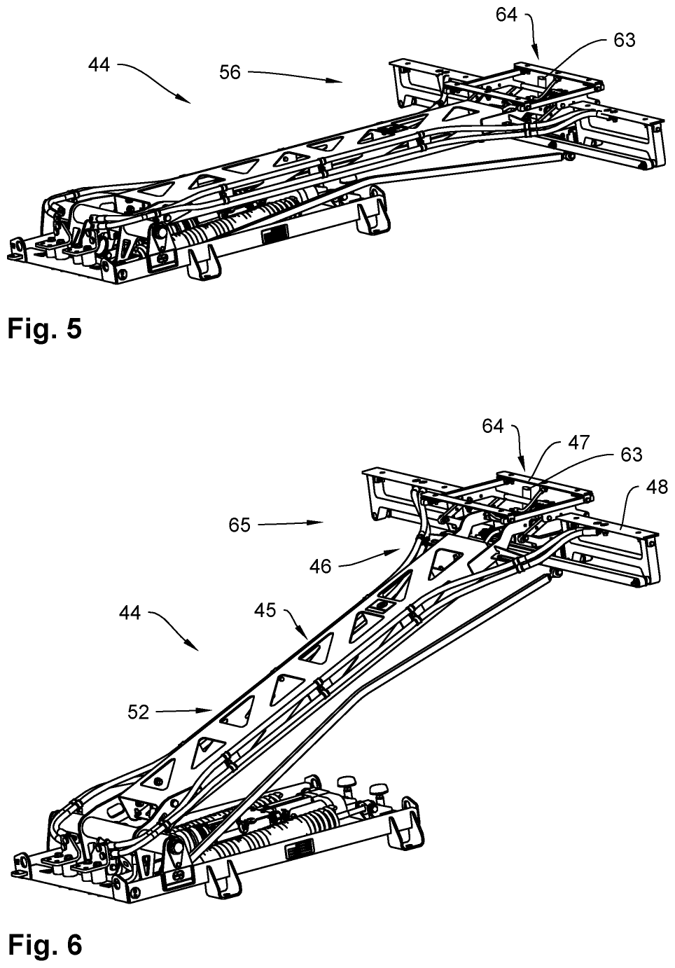

FIG. 5 shows the positioning unit of FIG. 3 in a retracted position in perspective view;

FIG. 6 shows the positioning unit of FIG. 3 in the contact position in a perspective view.

An overview of FIGS. 1 and 2 shows a first embodiment of a positioning unit 10 in various positions. A contacting of a charging contact surface 11 is only illustrated symbolically. The positioning unit 10 comprises an articulated arm device 12 and an adjustment drive 13 for driving the articulated arm device 12. The articulated arm device 12 is designed as a single-arm system 14 and comprises an upper scissor 15 with an upper scissors arm 16 and an upper coupling rod 17 as well as a lower scissor 18 with a lower scissors arm 19 and a lower coupling rod 20. An upper coupling link 21 is swivel-mounted to the upper scissors arm 16, so that a mount 22 of the positioning unit 10 for an electrical charging contact (not shown) of the positioning unit 10 can always be moved parallel to a horizontal plane 23. For this purpose, the upper coupling link 21 is connected to the upper coupling rod 17 via an axis 38. The lower scissors arm 19 and the lower coupling rod 20 are swivel-mounted to fixed bearings 24 and 25, respectively, of a holding frame 26 of the positioning unit 10. The lower scissors arm 19 is swivel-mounted to the upper scissors arm 16 via an axis 27. A swivel movement of the upper scissors arm 16 therefore leads to a parallel movement of the mount 22 relative to the horizontal plane 23.

The adjustment drive 13 is a linear drive 28. A spring device 29 of the positioning unit 10 is formed with a restoring spring 30 that is formed as a tension spring 31. The tension spring 31 is attached to a fixed bearing 31 on the holding frame 26 and to an axis 33 of a lever 34. Together with the axis 33 and the tension spring 31, the lever 34 forms a restoring gear 35. Depending on the position of the articulated arm device 12, the lever 34, which is mounted for co-rotation with the lower scissors arm 19, is swung relative to the tension spring 31 so that an effective length of the lever 34 is shortened or extended. In a retracted position 36 and in a contact position 37 of the positioning unit 10, the tension spring 31 has a direct effect on the axis 33. If the articulated arm device 12 is extended further downwards, an effective length of the lever 34 is shortened significantly through swiveling of the same. Therefore, it is possible to adapt the tension spring 31 or its effective restoring force to a position of the positioning unit 10. The articulated arm device 12 together with the adjustment drive 13 has a design-related gravitational force including a charging contact (not shown) that works on the charging contact or the mount 22. The tension spring 31 causes a spring force or a restoring force that exceeds the gravitational force so that, irrespective of a position of the positioning unit 10, return of the positioning unit to the retracted position 36 is ensured at all times even in the event of a power outage.

A lever 39 that has a control gear 40 for the articulated arm device 11 is firmly fixed to the articulated arm device 12 or the lower scissors arm 19. The linear drive 28 is swivel-mounted on an axis 41 of the lever 39. Furthermore, the linear drive 28 is firmly connected to the holding frame 26 via an axis 42. The linear drive 28 is driven by an electric motor 43 and is not self-locking. This way, for example in the event of a power outage, the tension spring 31 can automatically move the articulated arm device 12 from the contact position 37 to the retracted position 36, which causes the linear drive 28 to be retracted. Therefore, the linear drive also serves for the damping of a movement of the articulated arm device 12. Furthermore, the positioning unit 10 shown comprises a control device (not shown) to which the electric motor 43 is connected. A torque of the electric motor 43 is detected by means of the control device, wherein the control device controls the torque of the electric motor 43 in accordance with a contact force that is exerted onto the charging contact surface 11 by the charging contact (not shown). The contact force is strong enough for forming an electric contact and can be formed in a substantially constant manner or at the same level in the contact position 37 as well as in any other optional contact position since the torque of the electric motor 43 is controlled.

The adjustment drive 13 or the electric motor 43 can be controlled using the control device (not shown). A sensor 61 of a sensor device 62 is disposed on the mount 22 of the lower scissor arm 19, said sensor 61 being capable of detecting a relative distance from the sensor 61 and the plane 23 or charging contact surface 11. Thus, a relative distance between the charging contact (not shown) and the charging contact surface 11 can also be determined. Since the sensor device 62 is coupled with the control device, a speed of the charging contact during movement of the charging contact from the retracted position 36 into the contact position 37 can be controlled by the control device in accordance with a measured or detected relative distance between the charging contact and the charging contact surface 11.

An overview of FIGS. 3 to 6 shows a second embodiment of a positioning unit 44 that is mounted on the roof of an electrically driven vehicle (not shown). The positioning unit 44 substantially comprises an articulated arm device 45, at the end 46 of which charging contacts 47 and 48 are located for the contacting of a charging contact surface (not shown) above the vehicle. Furthermore, the positioning unit 44 comprises an adjustment drive 49 and a spring device 50 as well as a holding frame 51. The articulated arm device 45 is formed as a single-arm system 52 similar to the previously described single-arm system. The spring device 50 comprises two tension springs 53 that are formed as lifting springs 54 and exert a lifting force on the articulated arm device 45. Here, the lifting force is determined in a way that a gravitational force of the articulated arm device 45 together with the charging contacts 47 and 48 is greater than the lifting force, so that in the event of a power outage, for example, the articulated arm device 45 descends from a working position 55 or a contact position (not shown) to a retracted position 56 in all cases. The adjustment drive 49 therefore comprises a linear drive 57 without self-locking having an electric motor 58 that is connected to and controlled by a control device (not shown) of the positioning unit 44. The control device detects a torque of the electric motor 58, wherein the control device controls the torque of the electric motor 58 in such a way that a defined contact force is formed on the charging contacts 47 and 48. The linear drive 57 for its part comprises a trapezoidal thread spindle (not shown) that, in this case, is accommodated in a housing 59 of the linear drive 57 and acts on a drive rod 60 by means of a nut. Therefore, the articulated arm device can be moved to the contact position 55 or to the retracted position 56 by means of a movement of the drive rod 60.

The positioning unit 44 also has a sensor 63 of a sensor device 64, wherein the sensor 63 is attached to the single-arm system 52 adjacent to the charging contacts 47. In FIG. 3 in particular, the positioning unit 44 and the single-arm system 52 are illustrated in a working position 55. The working position 55 is far enough away from a contact position 65 that the charging contacts 47 and 48 are still located at a relative distance A from a charging contact surface (not shown). The charging contact surface is indicated by a line 66, and the working position 55 is indicated by a line 67 disposed parallel relative thereto. Here, the charging contact surface is located in a detection range 68 of the sensor 63 so that a speed of the charging contacts 47 and 48 during movement from the retracted position 56 into the contact position 65 can be controlled by the control device in accordance with the relative distance A between the charging contacts 47 and 48 and the charging contact surface or line 66.

1. A positioning unit for forming an electrically conductive connection between a stationary charging station and a vehicle, wherein an electrical charging contact of the positioning unit is moveable relative to a charging contact surface and contacted with the charging contact surface by means of the positioning unit,
wherein the positioning unit has an articulated arm device and a drive device configured to drive the articulated arm device,
wherein the electrical charging contact is positioned between a contact position for power transmission and a retracted position for power interruption by means of the articulated arm device,
wherein the drive device has an adjustment drive configured to form an adjustment force acting on the articulated arm device,
wherein the drive device has a control device configured to actuate the adjustment drive,
wherein the drive device has a sensor device configured to detect the charging contact surface or the charging contact,
wherein the sensor device is coupled with the control device,
wherein a speed of the charging contact during a movement of the charging contact from the retracted position to the contact position is controlled by the control device in accordance with a relative distance between the charging contact and the charging contact surface,
wherein the adjustment drive in configured to form a contact force acting on the charging contact surface,
wherein the adjustment drive has the control device and an electric motor, the control device being configured to actuate the electric motor.

2. (canceled)

3. The positioning unit of claim 1, wherein the adjustment drive is a linear drive.

4. The positioning unit of claim 1, wherein
the sensor device has at least one sensor, the at least one sensor including at least one of a mechanical switch, an inductive sensor, a capacitive sensor, a magnetic sensor, an ultrasonic sensor, a radar sensor, and an optical sensor.

5. The positioning unit of claim 4, wherein
the at least one sensor is disposed on the articulated arm device or on the charging contact surface.

6. The positioning unit of claim 1, wherein
at least one of the adjustment drive and the articulated arm device has at least one of a displacement sensor and a position sensor.

7. The positioning unit of claim 1, wherein
the drive device has a spring device mechanically cooperating with the adjustment drive.

8. The positioning unit of claim 7, wherein
the positioning unit comprises a holding device configured to fasten the positioning unit above a vehicle on a pole or an underpass, wherein the spring device has at least one restoring spring dimensioned to form a restoring force acting on the articulated arm device in a first direction, wherein the restoring force is greater than a gravitational force of the articulated arm device acting on the restoring spring in a second direction, the second direction being opposite to the first direction.

9. The positioning unit of claim 7, wherein
the positioning unit comprises a holding device configured to fasten the positioning unit on a roof of a vehicle, wherein the spring device comprises at least one lifting spring dimensioned to form a lifting force acting on the articulated arm device in a third direction, wherein the lifting force is smaller than a gravitational force of the articulated arm device acting on the lifting spring in a fourth direction, the fourth direction being opposite to the third direction.

10. The positioning unit of claim 1, wherein
the drive device is configured for coupling with a data bus of a vehicle.

11. A method for forming an electrically conductive connection between a stationary charging station and a vehicle, wherein an electrical charging contact of a positioning unit is moved relative to a charging contact surface and contacted with the charging contact surface by means of the positioning unit, wherein an articulated arm device of the positioning unit is driven by a drive device of the positioning unit, wherein the charging contact is positioned between a contact position for power transmission and a retracted position for power interruption by means of the articulated arm device, wherein an adjustment force acting on the articulated arm device is formed by means of an adjustment drive of the drive device, and wherein the drive device of the adjustment drive is actuated by a control device,
the method comprising:
detecting the charging contact surface or the charging contact with a sensor device of the drive device, wherein the sensor device is coupled with the control device,
controlling a speed of the charging contact during a movement of the charging contact from the retracted position to the contact position by the control device in accordance with a relative distance between the charging contact and the charging contact surface,
and
moving the charging contact from the retracted position to the contact position at a first speed in a first portion of a movement and at a second speed in a second portion of the movement section before reaching the contact position, the first speed being at least one of a constant speed and a maximum speed, the second speed being slower than the first speed.

12. The method of claim 11, wherein
during the movement of the charging contact from the retracted position to the contact position, positively accelerating the charging contact at a first moment of time and negatively accelerating the charging contact at a later point in time.

13. (canceled)

14. The method of claim 13, wherein said moving the charging contact at the first speed includes moving the charging contact at the first speed that is ≥100 mm/s, preferably ≥360 mm/s, particularly preferably ≥500 mm/s.

15. The method of claim 13, wherein
upon arrival to the contact position, the second speed is at least 70%, preferably 50%, particularly preferably 30% of the first speed or 0 mm/s.

16. The method of claim 11, comprising
reducing the speed of the charging contact during said movement of the charging contact prior to arrival to the contact position at a relative distance of ≤150 mm, preferably ≤100 mm, particularly preferably ≤50 mm.

17. The method of claim 11, comprising
reducing the speed of the charging contact during said movement of the charging contact, prior to arrival to the contact position, according to a linear function or an approximation function.

18. The method of claim 11, comprising
continuously transmitting, with at least one sensor of the sensor device, a distance value or a defined threshold of the relative distance to the control device.

19. The method of claim 11, comprising
exerting a contact force on the charging contact surface by the adjustment drive, wherein an electric motor of the adjustment drive is actuated by the control device.

20. The method according to claim 19, comprising detecting a torque of the electric motor with the control device, wherein the contact force is controlled by the control device in accordance with the torque of the electric motor.

21. The method of claim 11, comprising
detecting the charging station or the vehicle with another sensor device of the drive device, wherein the control device determines a relative distance of the charging contact in the retracted position and in the contact position, wherein the control device initiates a movement of the charging contact out of the retracted position before the vehicle stops at the charging station.

22. The method of claim 21, comprising determining a relative height of at least one of the charging contact and the contact position above a road, wherein the control device determines a height of the vehicle above the road.
